(19) United States
(12) Patent Application Publication
(10) Pub. No.: US 2026/0199827 A1
(43) Pub. Date: Jul. 16, 2026

(54) HIGH EFFICIENCY ELECTRO-PHOTOCATALYSTS

(71) Applicant: THE REGENTS OF THE UNIVERSITY OF COLORADO, A BODY CORPORATE, Denver, CO (US)

(72) Inventor: Longji CUI, Boulder, CO (US)

(21) Appl. No.: 19/138,541

(22) PCT Filed: Dec. 13, 2023
(86) PCT No.: PCT/US2023/083888

§ 371 Date: Jun. 12, 2025

Related U.S. Application Data
(60) Provisional application No. 63/432,346, filed on Dec. 13, 2022.

(51) Int. Cl. B01D 53/32; B01D 53/86

(52) U.S. Cl. CPC B01D 53/32; B01D 53/8612; B01D 53/8628; B01D 53/864; B01D 2255/1026; B01D 2255/20761; B01D 2257/304; B01D 2257/402; B01D 2257/504; B01D 2257/7025; B01D 2258/06

(57) ABSTRACT

A plasmonic nanostructure comprising one or more clustered or otherwise ensembled nanoparticles and/or nanorods and one or more nanogaps between the nanoparticles and/or nanorods. An external electrical source applies a bias voltage to the nanoparticles and/or nanorods, applying an electrical field across at least a portion of the nanogaps, so as to generate hot carriers in the proximity of the nano gaps. Such hot carriers can be used in a catalytic method for conversion of greenhouse gases, other atmospheric pollutants, or other materials to less harmful, or even useful products.

### CROSS-REFERENCE TO RELATED APPLICATIONS

The present application claims the benefit of and priority to U.S. Provisional Patent Application Ser. No. 63/432,346, filed Dec. 13, 2022, entitled “HIGH EFFICIENCY ELECTRO-PHOTOCATALYSTS,” the disclosure of which is herein incorporated by reference in its entirety.

### BACKGROUND

Controlling and steering chemical reactions at milder conditions than are typical in thermal catalysis has long been a central desire in synthetic chemistry. For example, such reactions may be used to generate sustainable chemical fuels while minimizing any environmental damage. A great number of chemical reactions involving conversion of greenhouse gases and other atmospheric pollutants (e.g., CO₂, CH₄, N₂O, and fluorinated gases) to less harmful or even useful products are not thermodynamically favored under mild conditions and therefore consume high energy when using conventional thermal catalysis to produce such, which is not cost effective. H₂S is another atmospheric pollutant which is an extremely hazardous substance to human health. While a one-step decomposition process for H₂S to high value H₂ and sulfur is theoretically possible, it is challenging to realize using traditional methods. Accordingly, there are significant challenges to be addressed in this field.

The subject matter claimed herein is not limited to embodiments that solve any disadvantages or that operate only in environments such as those described above. Rather, this background is only provided to illustrate an exemplary technology area where some embodiments described herein may be practiced.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An exemplary disclosed embodiment includes a plasmonic nanostructure comprising one or more clustered or otherwise ensembled nanoparticles and one or more nanogaps between the one or more clustered or otherwise ensembled nanoparticles. An external electrical source applies a bias voltage across at least a portion of the one or more nanogaps so as to generate hot carriers, e.g., in the proximity of the nano gap.

Another embodiment is directed to a method for the generation of hot carriers within a plasmonic nanostructure, such as that described above. The method comprises applying an external electrical source to the plasmonic nanostructure to electrically generate hot carriers.

Another embodiment is directed to a catalytic method for conversion of greenhouse gas other atmospheric pollutants, or other materials to a different, less harmful, or even useful product, the method employing generation of hot carriers within a plasmonic nanostructure. Such a method includes applying an electrical voltage to the plasmonic nanostructure so as to generate hot carriers from a nanogap of the plasmonic nanostructure, the hot carriers catalyzing reaction of the greenhouse gas or other atmospheric pollutant to the less harmful, or even useful product. While principally described in the context of conversion of greenhouse gases or other atmospheric pollutants, it will be appreciated that such a catalytic method can also be applied in the reactive conversion of other species as well, e.g., where such reaction is kinetically and/or thermodynamically unfavorable under conventional reaction conditions, using conventional catalysts. Such additional uses are contemplated, and within the scope of the present disclosure.

In any of the described embodiments, the greenhouse gas or other atmospheric pollutant or other material to be reacted may comprise at least one of CO₂, CH₄, N₂O, H₂S, a fluorocarbon, or a perfluorocarbon.

In any of the described embodiments, the method may catalyze the decomposition of N₂O to O₂ and N₂.

In any of the described embodiments, the method may catalyze the conversion of CH₄ and CO₂ to CO and H₂ (e.g., dry methane reforming).

In any of the described embodiments, the method may catalyze the conversion of H₂S to H₂ and S.

In any of the described embodiments, the method may not employ laser or other light for generation of the hot carriers.

In any of the described embodiments, the method may be carried out at a temperature of no greater than 100° C. and/or at or near atmospheric pressure.

In any of the described embodiments, the method may be carried out at a temperature of no greater than 50° C.

In any of the described embodiments, the nanostructure may comprise nanorods.

In any of the described embodiments, the nanostructure may comprise Cu nanoparticles.

In any of the described embodiments, the nanostructure may comprises Ru nanoparticles.

In any of the described embodiments, the nanostructure may comprise Cu and/or Ru nanoparticles or nanorods.

In any of the described embodiments, the nanostructure may comprise nanoparticles or nanorods having a size from 1 nm to 1000 nm, or from 1 nm to 100 nm.

Elements or features described in relation to any embodiment depicted and/or described herein may be combinable with elements or features described in relation to any other embodiment depicted and/or described herein.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 schematically illustrates an electrically powered plasmonic catalyst made of ensembled nanostructures, according to the present disclosure.

### DETAILED DESCRIPTION

Disclosed embodiments provide for innovative methods, systems, and structures for efficient creation of hot carriers for use in providing a plasmonic catalytic effect. In at least one embodiment, instead of utilizing lasers or other lights sources to generate hot carriers, disclosed embodiments utilize an external electrical source to apply a bias voltage and current directly to a plasmonic nanostructure. Such a plasmonic nanostructure includes nanogaps. The application of a relatively small electrical bias voltage to the plasmonic nanostructure may cause the generation of hot carriers in the proximity of the one or more nanogaps. Such hot carriers are capable of catalyzing reactions that are otherwise kinetically and/or thermodynamically unfavorable. Such a catalyst may exhibit increased reaction yield (e.g., by an order of magnitude), while maintaining high product selectivity, all while consuming very little energy as compared to conventional thermal catalysis.

Conventional catalysts such as metal surfaces, enzymes, and photocatalysts, are widely used to increase reaction rates, but constantly suffer from limitations in reactivity, selectivity, and stability. In fact, most industrial catalytic processes rely heavily on high-temperature and/or high-pressure thermal catalysis to reach the required efficiency. Plasmonic photocatalysis has emerged in recent years as an exciting new avenue to induce higher reaction rates while reducing the energy cost associated with traditional catalysis. Plasmonic catalysis uses plasmonic resonances of metallic nanostructures to generate hot electrons and holes (i.e., electrical carriers at energy levels much higher than the Fermi level). These hot carriers can overcome the high activation barriers in chemical reactions under ambient conditions (e.g., at or near ambient temperature and pressure). Through the highly efficient conversion process of hot carrier energy into molecular transformations, plasmonic photocatalysts enable high selectivity with a much higher reaction efficiency (e.g., experimental reports show a 10-20 fold enhancement compared to thermal catalysis). However, a major bottleneck in plasmonic photocatalysis is the limitation imposed by the need for high-power pulsed laser or LED illumination which is used in previously proposed systems to excite the narrowband plasmonic resonances of a given nanostructure to produce hot carriers in the near field of the nanostructure. Sunlight driven chemical transformations are too low in excitation intensity at the resonance wavelength. Higher light intensities are required, e.g., requiring the use of a laser. In addition, with such light activated systems, the narrow illumination area and small penetration depth of such illumination light also prohibit large scale and three-dimensional applications of such plasmonic photocatalysts.

Additional details of the state of the art of such plasmonic nanostructures are disclosed in Zhou, L. et al. Quantifying hot carrier and thermal contributions in plasmonic photocatalysis. Science 362, 69-72 (2018); Zhou, L. et al. Light-driven methane dry reforming with single atomic site antenna-reactor plasmonic photocatalysts. Nat. Energy 5, 61-70 (2020); Cortés, E. et al. Challenges in Plasmonic Catalysis. ACS Nano 14, 16202-16219 (2020); Cui, L. et al. Electrically Driven Hot-carrier Generation and Above-threshold Light Emission in Plasmonic Tunnel Junctions. Nano Lett. 20, 6067-6075 (2020); and Cui, L. et al. Thousand-fold Increase in Plasmonic Light Emission via Combined Electronic and Optical Excitations. Nano Lett. 21, 2658-2665 (2021). Each of the foregoing is herein incorporated by reference, in its entirety.

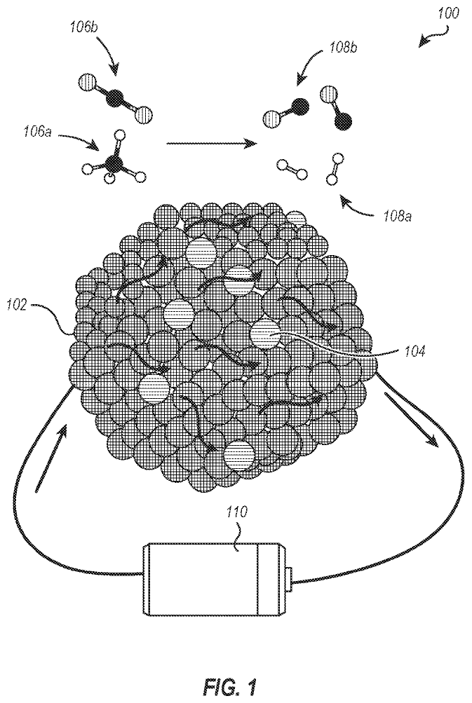

To overcome these challenges, the present disclosure is based on a novel plasmonic hot carrier generation mechanism, where hot carriers are electrically generated in nano-plasmonic junctions. These junctions include electron tunneling nanogaps that are formed when ensembles of nano-plasmonic structures (e.g., nanoparticles and/or nanorods) are aggregated into a macroscopic architecture, as schematically illustrated in FIG. 1. More importantly, under a bias voltage of a few volts from a simple cell battery, electrons can tunnel through the nanojunctions and excite plasmonic resonances in a broadband manner, which further undergoes non-radiative decay to produce a large number of hot carriers. As a result, the contemplated systems can operate in a dark environment, eliminating the need for costly optics and laser illumination.

By way of example, the applied voltage may be quite low, such as less than about 50 volts, less than about 30 volts, less than about 20 volts, or less than about 10 volts, such as from about 0.5 to about 10 volts, from about 1 to about 5 volts or from about 1 to about 3 volts. Additional ranges may be defined between any of the foregoing values, as endpoints of such a range. Such electrically powered catalytic embodiments enable highly efficient plasmonic catalytic reactions in ensembled nanostructures.

By designing and tailoring the nano-composite or other nanostructures from the bottom-up (e.g., selection of metal nanoparticles or nanorod materials, selection of particle or rod sizes, selection of particle geometry, etc.), a given nanostructure can be particular designed to enable favored hot-carrier induced molecular transformations in desired specific reactions. Such electrically powered plasmonic catalysts will thus open new avenues that merge plasmonic nanomaterials, photocatalysis, and green chemistry.

Exemplary embodiments provide an efficient yet inexpensive plasmonic nanoparticle catalyst that leverages electrically driven plasmonic nanostructures to boost various greenhouse gas reduction related chemical reactions to minimize their environmental adverse effects. Of course, other reactions that are similarly kinetically and/or thermodynamically unfavored under mild conditions may also benefit from such catalysts. Examples of such reactions include, but are not limited to methane dry reforming (CH₄+CO₂→2CO+2H₂), carbon-fluorine activation to reduce fluorocarbons or perfluorocarbons, and decomposition of nitrous oxide (2N₂O→O₂+2N₂). Each of these reactions are recognized to be kinetically and/or thermodynamically unfavorable using traditional thermal catalysis.

The presently contemplated embodiments, based on electrically generated energetic hot-carriers in plasmonic nanostructures to facilitate bond activation, can improve the reaction yield by an order of magnitude (10×) or more while maintaining high product selectivity and consuming significantly less energy, as the reactions can be carried out under mild temperature and pressure conditions. For example, in an embodiment, such reactions may be carried out at temperatures of no greater than about 100° C., no greater than about 50° C., such as typical ambient temperatures (e.g., from about 10° C. to about 40° C., or from about 20° C. to about 25° C.). Similarly, such reactions may be carried out at or near atmospheric pressure, e.g., under unpressurized conditions (i.e., 0 psig). The ability to carry out such reactions without requiring pressurization greatly reduces the capital expense associated with any such system. The ability to carry out such reactions while requiring minimal or no external heating also reduces capital expenses, and greatly reduces operational expenses associated with providing such heat, which is typically required for conventional thermal catalysis. Rather, the disclosed embodiments may comprise battery powered, portable reactor modules that may make plasmonic catalysts inexpensively and widely available to revolutionize the accessibility of green chemistry and sustainable chemical products.

FIG. 1 schematically depicts such an exemplary electrically powered plasmonic catalyst 100 made of ensembled nanostructures. As illustrated, in an embodiment, the ensembled (e.g., clustered) nanoparticles may include one or more types of nanoparticles or nanorods. The illustrated configuration is shown as including first nanoparticles or first nanorods 102 and second nanoparticles or second nanoparticles 104, ensembled or clustered together, as shown. The illustrated curvy arrows shown within the ensembled or clustered nanostructures catalyst represent tunneling electrons, which are able to pass through the nanostructure, and generate hot electrons or holes in the vicinity of nanogaps that separate the nanoparticles or nanorods 102 and 104, when the bias voltage is applied, e.g., from electrical source 110.

FIG. 1 illustrates conversion of one or more first chemical species 106a and 106b (e.g., CH₄ and CO₂) to less harmful, and/or more desirable or useful second chemical species 108a and 108b (e.g., H₂ and CO).

While described above in the context of a specific chemical reaction (e.g., CH₄+CO₂→2CO+2H₂), it will be appreciated that any of a wide variety of reactions are possible. Nonlimiting examples of such reactions include the decomposition of H₂S to H₂ and S, the decomposition of N₂O to O₂ and N₂, or the decomposition or other reaction of a fluorocarbon, or perfluorocarbon. A wide variety of other reactions are also possible, e.g., particularly reactions that are kinetically and/or thermodynamically unfavorable, under conventional conditions.

By way of further example, the employed nanoparticles or nanorods may include any of a wide variety of suitable materials. In an embodiment, the nanoparticles or nanorods comprise or are metals. Examples of such include, but are not limited to Cu, Ru, Fe, Pd, Al, Au, Ag and combinations thereof.

Where combinations of different nanoparticles and/or nanorods are employed, any given type of nanoparticle or nanorod may be present in an amount of at least 0.05%, at least 0.1%, at least 0.2%, at least 0.3%, at least 0.5%, at least 1%, or other value, relative to the total included nanoparticles and/or nanorods.

In an embodiment, the nanoparticles may have a size ranging from about 1 nm to about 1000 nm, or from about 1 nm to about 100 nm. Where nanorods are employed, the nanorods may have a diameter and/or length that may be within such a range (e.g., about 1 nm to about 1000 nm, or from about 1 nm to about 100 nm).

In an embodiment, the ensembled or clustered nanostructure may have a macro size (e.g., diameter and/or length) ranging from 10 μm to 10 mm.

While a battery 110 is schematically shown in FIG. 1, the external electrical source may comprise a battery, a solar panel, a capacitor, a power supply, or any other desired power source.

In an embodiment, the external electrical source may apply a current that comprises, e.g., from about 1 to about 10 microamps per gap within the plasmonic nanostructure.

In an embodiment, the applied voltage may be quite low, such as less than about 50 volts, less than about 30 volts, less than about 20 volts, or less than about 10 volts, such as from about 1 to about 10 volts from about 1 to about 5 volts, or from about 1 to about 3 volts.

In an embodiment, product selectivity may be high, such as at least 80%, at least 90%, at least 95%, or at least 99%.

In at least one embodiment, the electrically powered plasmonic catalyst 100 may enable highly efficient greenhouse gas reduction related chemical reactions. In the depicted electrically powered plasmonic catalyst 100, “Hot e⁻/h⁺” refers to electrically generated hot electrons and/or holes. Disclosed embodiments may comprise a plasmonic catalyst device with pre-designed nanofabricated arrays of nanojunction samples. Additional embodiments may comprise large-scale plasmonic catalysts with tailored composition, structure, and size characteristics for particular chemical reactions of interest. Disclosed embodiments may further be integrated into a chemical reactor with an embedded power source for use in reducing greenhouse gases. In an embodiment, battery or other electrically powered, portable reactor modules could be provided.

The plasmonic catalysts may be prepared using any suitable techniques, as will be apparent to those of skill in the art, such as antenna-reactor surface alloying, 3D nanoparticle assembly, and/or planar nanofabrication.

In a recent report, the United Nations noted that the available national action plans will collectively contribute to 11% increased greenhouse gas emissions by 2030 compared to 2010, far short of the 45% reduction goal set in the Paris Agreement. Transition to a net-zero world will not be possible by 2050 without transformative inventions to effectively process the excess emissions from continued use of fossil fuels, and to produce renewable chemical resources to overcome the hurdles facing the proliferation of existing renewables. Disclosed embodiments represent an important step forward in this direction and could make a profound impact to help cool down the ever-warming world.

As used herein, the terms “comprising,” “including,” “containing,” “characterized by,” and grammatical equivalents thereof are inclusive or open-ended terms that do not exclude additional, unrecited elements or method steps, but also include the more restrictive terms “consisting of” and “consisting essentially of” and grammatical equivalents thereof. As used herein, the term “may” with respect to a material, structure, feature or method act indicates that such is contemplated for use in implementation of an embodiment of the disclosure and such term is typically used in preference to the more restrictive term “is” so as to avoid any implication that other, compatible materials, structures, features and methods usable in combination therewith should or must be, excluded.

All publications, patents and patent applications cited herein are hereby incorporated by reference in their entirety to the same extent as if each individual publication, patent or patent application was specifically and individually indicated to be incorporated by reference. For example, any of the conditions or starting materials described in the inventor's earlier applications, already referenced, may be adapted for use according to the methods, metal carbide fibers, or articles disclosed herein.

In addition, unless otherwise indicated, numbers expressing quantities, constituents, distances, or other measurements used in the specification and claims are to be understood as optionally being modified by the term “about” or its synonyms. When the terms “about,” “approximately,” “substantially,” or the like are used in conjunction with a stated amount, value, or condition, it may be taken to mean an amount, value or condition that deviates by less than 20%, less than 10%, less than 5%, less than 1%, less than 0.1%, or less than 0.01% of the stated amount, value, or condition.

As used herein, the term “between” includes any referenced endpoints. For example, “between 2 and 10” includes both 2 and 10.

Some ranges are disclosed herein. Additional ranges are also contemplated, for example, between any values disclosed herein, as endpoints of such a range.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A catalytic method for conversion of a greenhouse gas, other atmospheric pollutant, or other material to a different less harmful or useful product, the method employing generation of hot carriers within a plasmonic nanostructure, the method comprising:
applying an electrical voltage to the plasmonic nanostructure so as to generate hot carriers from a nanogap of the plasmonic nanostructure, the hot carriers catalyzing reaction of the greenhouse gas, other atmospheric pollutant, or other material to the less harmful or useful product.

2. The method of claim 1, wherein the greenhouse gas, other atmospheric pollutant or other material comprises at least one of CO₂, CH₄, N₂O, H₂S, a fluorocarbon, or a perfluorocarbon.

3. The method of claim 1, wherein the method catalyzes the decomposition of N₂O to O₂ and N₂.

4. The method of claim 1, wherein the method catalyzes the conversion of CH₄ and CO₂ to CO and H₂.

5. The method of claim 1, wherein the method catalyzes the conversion of H₂S to H₂ and S.

6. The method of claim 1, wherein the method does not employ laser or other light for generation of the hot carriers.

7. The method of claim 1, wherein the method is carried out at a temperature of no greater than about 100° C. and/or at or near atmospheric pressure.

8. The method of claim 1, wherein the method is carried out at a temperature of no greater than about 50° C.

9. The method of claim 1, wherein the nanostructure comprises nanorods.

10. The method of claim 1, wherein the nanostructure comprises Cu nanoparticles.

11. The method of claim 1, wherein the nanostructure comprises Ru nanoparticles.

12. The method of claim 1, wherein the nanostructure comprises Cu and/or Ru nanoparticles and/or nanorods.

13. The method of claim 1, wherein the nanostructure comprises nanoparticles having a size from about 1 nm to about 1000 nm, or from about 1 nm to about 100 nm.

14. A method for the generation of hot carriers within a plasmonic nanostructure, the method comprising:
applying an external electrical source to a plasmonic nanostructure to electrically generate hot carriers.

15. The method of claim 14, wherein the method does not employ laser or other light for generation of the hot carriers.

16. The method of claim 14, wherein the method is carried out at a temperature of no greater than about 100° C. and/or at or near atmospheric pressure.

17. The method of claim 14, wherein the method is carried out at a temperature of no greater about 50° C.

18. The method of claim 14, wherein the nanostructure comprises nanorods.

19. The method of claim 14, wherein the nanostructure comprises Cu nanoparticles.

20. The method of claim 14, wherein the nanostructure comprises Ru nanoparticles.

21. The method of claim 14, wherein the nanostructure comprises Cu and/or Ru nanoparticles and/or nanorods.

22. The method of claim 14, wherein the nanostructure comprises nanoparticles having a size from about 1 nm to about 1000 nm, or from about 1 nm to about 100 nm.

23. A plasmonic nanostructure comprising:
one or more clustered nanoparticles or nanorods;
one or more nanogaps between the one or more clustered nanoparticles or nanorods; and
an external electrical source configured to apply a bias voltage across at least a portion of the one or more nanogaps, so as to generate hot carriers.

24. The plasmonic nanostructure of claim 23, wherein the nanostructure comprises nanorods.

25. The plasmonic nanostructure of claim 23, wherein the nanostructure comprises Cu nanoparticles.

26. The plasmonic nanostructure of claim 23, wherein the nanostructure comprises Ru nanoparticles.

27. The plasmonic nanostructure of claim 23, wherein the nanostructure comprises Cu and/or Ru nanoparticles and/or nanorods.

28. The plasmonic nanostructure of claim 23, wherein the nanostructure comprises nanoparticles having a size from about 1 nm to about 1000 nm, or from about 1 nm to about 100 nm.
